(19) United States
(12) Patent Application Publication
(10) Pub. No.: US 2026/0017929 A1
(43) Pub. Date: Jan. 15, 2026

(54) DEVICE DATA PROCESSING

(71) Applicant: TENCENT TECHNOLOGY (SHENZHEN) COMPANY LIMITED, Shenzhen (CN)

(72) Inventors: Zhuang ZHANG, Shenzhen (CN); Junbin LI, Shenzhen (CN); Guanghua JIANG, Shenzhen (CN); Qi CUI, Shenzhen (CN); Shaoming WANG, Shenzhen (CN); Liangzhi LUO, Shenzhen (CN)

(73) Assignee: TENCENT TECHNOLOGY (SHENZHEN) COMPANY LIMITED, Shenzhen (CN)

(21) Appl. No.: 19/327,760

(22) Filed: Sep. 12, 2025

Related U.S. Application Data
(63) Continuation of application No. PCT/CN2024/089033, filed on Apr. 22, 2024.

(30) Foreign Application Priority Data
Jun. 27, 2023 (CN) 202310770292.6

(51) Int. Cl. G06V 10/77; G06T 5/10; G06T 5/50; G06T 5/70

(52) U.S. Cl. CPC G06V 10/7715; G06T 5/10; G06T 5/50; G06T 5/70; G06T 2207/20064; G06T 2207/20132; G06T 2207/20182; G06T 2207/20221

(57) ABSTRACT

Some aspects of the disclosure provide a method of device data processing. In some examples, a target image that is collected by a target camera component of a target device is obtained. A component imaging feature of the target camera component is extracted from the target image. The component imaging feature reflects photo response non-uniformity of the target camera component during imaging and is extracted based on high-frequency noise components in the target image with frequencies higher than a frequency threshold. A device fingerprint of the target device is generated based on the component imaging feature. Apparatus and non-transitory computer-readable storage medium counterpart embodiments are also contemplated.

### RELATED APPLICATIONS

The present application is a continuation of International Application No. PCT/CN2024/089033, filed on Apr. 22, 2024, which claims priority to Chinese Patent Application No. 202310770292.6, filed on Jun. 27, 2023. The entire disclosures of the prior applications are hereby incorporated by reference.

### FIELD OF THE TECHNOLOGY

This disclosure relates to the field of computer technologies, including a device data processing technology.

### BACKGROUND OF THE DISCLOSURE

A device fingerprint of a device is a device feature configured for uniquely identifying the device. In related art, the device fingerprint of the device may generally be generated based on some use information of the device (for example, working information of a processor of the device). However, as different devices may have the same or similar working conditions (for example, holders of different devices have the same or similar device using habits), a degree of distinction between device fingerprints generated for devices is not high. In addition, the working condition of the device may change, and consequently, the device fingerprint of the device also changes accordingly, making the device fingerprint of the device unstable and inaccurate. Therefore, how to generate a more accurate and more stable device fingerprint for the device becomes a problem to be urgently resolved.

### SUMMARY

This disclosure provides a device data processing method and apparatus, a product, a device, and a medium, to improve accuracy and stability of a device fingerprint generated for a target device.

Some aspects of the disclosure provide a method of device data processing. In some examples, a target image that is collected by a target camera component of a target device is obtained. A component imaging feature of the target camera component is extracted from the target image, the component imaging feature reflects photo response non-uniformity of the target camera component during imaging, and is extracted based on high-frequency noise components in the target image with frequencies higher than a frequency threshold. A device fingerprint of the target device is generated based on the component imaging feature.

Some aspects of the disclosure provide an apparatus that includes processing circuitry configured to perform the method of device data processing.

Some aspects of the disclosure also provide a non-transitory computer-readable storage medium storing instructions which when executed by at least one processor cause the at least one processor to perform the method of device data processing.

In an aspect, this disclosure provides a device data processing method, the method being performed by a computer device and including: obtaining a target image collected by a target camera component, the target camera component being a camera component in a target device; extracting a component imaging feature of the target camera component from the target image, the component imaging feature being configured for reflecting photo response non-uniformity of the target camera component during imaging; and generating a device fingerprint of the target device based on the component imaging feature.

In an aspect, this disclosure provides a device data processing apparatus, the apparatus including: an obtaining module, configured to obtain a target image collected by a target camera component, the target camera component being a camera component in a target device; an extraction module, configured to extract a component imaging feature of the target camera component from the target image, the component imaging feature being configured for reflecting photo response non-uniformity of the target camera component during imaging; and a generation module, configured to generate a device fingerprint of the target device based on the component imaging feature.

In an aspect, this disclosure provides a computer device, including a memory and a processor, the memory storing a computer program, and the processor executing the computer program to implement the method according to an aspect of this disclosure.

In an aspect, this disclosure provides a computer-readable storage medium, the computer-readable storage medium storing a computer program, and a processor executing the computer program to implement the method according to the foregoing aspect.

According to an aspect of this disclosure, a computer program product is provided, the computer program product including a computer program, and the computer program being stored in a computer-readable storage medium (e.g., non-transitory computer-readable storage medium). A processor (an example of processing circuitry) of a computer device reads the computer program from the computer-readable storage medium, and the processor executes the computer program to cause the computer device to perform the method provided in various implementations, for example, the foregoing aspect.

In this disclosure, a target image collected by a target camera component can be obtained, the target camera component being a camera component in a target device; a component imaging feature of the target camera component can be extracted from the target image, the component imaging feature being configured for reflecting photo response non-uniformity of the target camera component during imaging; and further, a device fingerprint of the target device can be generated based on the component imaging feature. Based on the method provided in this disclosure, the device fingerprint of the target device can be generated based on the component imaging feature of the target camera component in the target device. The component imaging feature is configured for reflecting the exclusive and inherent photo response non-uniformity of the target camera component, and has high uniqueness and stability, therefore, the device fingerprint of the target device that has a strong binding and association relationship with the target camera component is generated based on the component imaging feature, ensuring that the device fingerprint is stable, and can be configured for accurately identifying a target device having the target camera component.

### BRIEF DESCRIPTION OF THE DRAWINGS

FIG. 1 is a schematic structural diagram of network architecture according to this disclosure.

FIG. 2 is a schematic diagram of a scene of generating a device fingerprint according to this disclosure.

FIG. 3 is a schematic flowchart of a device data processing method according to this disclosure.

FIG. 4 is a schematic diagram of a scene of variance estimation according to this disclosure.

FIG. 5 is a schematic flowchart of a feature extraction method according to this disclosure.

FIG. 6 is a schematic diagram of a scene of a network training method according to this disclosure.

FIG. 7 is a schematic diagram of a scene of network training according to this disclosure.

FIG. 8 is a schematic flowchart of performing device classification based on a device fingerprint according to this disclosure.

FIG. 9 is a schematic structural diagram of a device data processing apparatus according to this disclosure.

FIG. 10 is a schematic structural diagram of a computer device according to this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

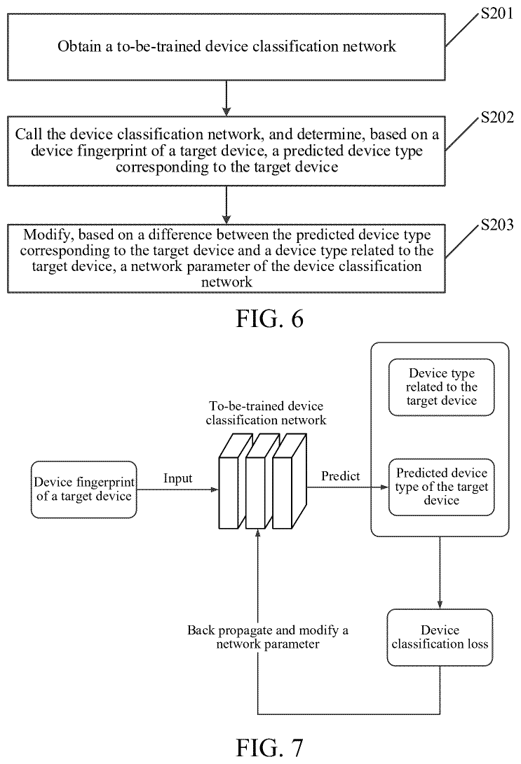

This disclosure mainly relates to machine learning in artificial intelligence. In some aspect, a machine learning technology is applied to train a device classification network, to identify and classify a device based on a device fingerprint of the device through the device classification network. For details, refer to related descriptions in the following embodiment corresponding to FIG. 6.

This disclosure further relates to a related technology of a blockchain. In some aspect, in this disclosure, the device fingerprint generated for the device may be uploaded and stored on the blockchain, to ensure security of the device fingerprint.

All data (for example, related data such as an image collected by a target camera component or an image collected by a verification device by using a camera component) collected in this disclosure is collected with permission and authorization of an object (for example, a user, an institution, or an enterprise) to which the data belongs. In addition, collection, disclosure, and processing of the related data need to comply with related laws, regulations, and standards in related countries and regions.

Examples of terms involved in the aspects of the disclosure are briefly introduced. The descriptions of the terms are provided as examples only and are not intended to limit the scope of the disclosure.

Device fingerprint refers to a device feature configured for uniquely identifying a device, or a unique device identifier.

PRNU refers to Photo response non-uniformity, also is referred to as a non-uniform photo response feature, can be a noise feature. A PRNU feature is a main component of a pattern noise of a sensor. Due to a production technology defect of a difference in thicknesses of silicon coatings between pixels of the sensor, a slight difference exists in photosensitive features of photosensitive elements of an imaging device, causing a fixed error distribution in an entire photosensitive array of the photosensitive elements of the imaging device. The fixed error distribution is also implicitly included, in a form of a multiplicative factor, in an image photographed by using the sensitive elements of the imaging device.

The photosensitive elements of the imaging device may be a photosensitive element (for example, a photosensitive sensor in a camera) in a camera component (for example, a camera in a device).

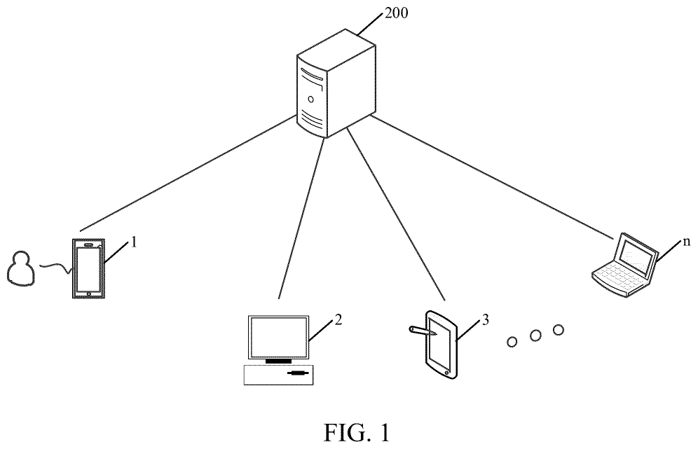

Referring to FIG. 1, FIG. 1 is a schematic structural diagram of network architecture according to this disclosure. As shown in FIG. 1, the network architecture may include a server 200 and a terminal device cluster. The terminal device cluster may include one terminal device or a plurality of terminal devices, and a quantity of the terminal devices is not limited herein. As shown in FIG. 1, the plurality of terminal devices may include a terminal device 1, a terminal device 2, a terminal device 3, . . . , and a terminal device n. As shown in FIG. 1, the terminal device 1, the terminal device 2, the terminal device 3, . . . , and the terminal device n all may be connected to the server 200 through network connection, so that each terminal device can exchange data with the server 200 through the network connection.

The server 200 shown in FIG. 1 may be an independent physical server, a server cluster or a distributed system formed by a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device may be an intelligent terminal such as a smartphone, a tablet computer, a laptop computer, a desktop computer, or a smart television. An embodiment of this disclosure is described below by using communication between the terminal device 1 and the server 200 as an example.

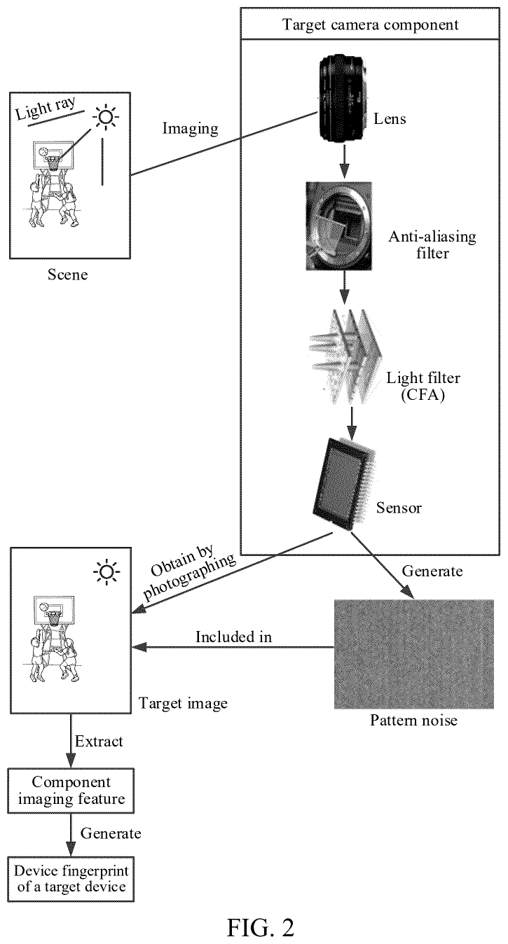

Referring to FIG. 2, FIG. 2 is a schematic diagram of a scene of generating a device fingerprint according to this disclosure. As shown in FIG. 2, the foregoing terminal device 1 may include a camera component, and the camera component may be a camera in the terminal device 1. In this disclosure, the terminal device 1 may be referred to as a target device, and the camera component in the target device may be referred to as a target camera component.

In an embodiment, the target camera component may include components for imaging, such as a lens, an anti-aliasing filter, a light filter (e.g., color filter array (CFA)), and a sensor. The target camera component may photograph a scene (or a scenario), and a photographed image sequentially passes through the lens, the anti-aliasing filter, the light filter, and the sensor in the target camera component. Finally, a photographed target image may be obtained. The target image is a picture or a video shot by the target camera component.

In the embodiment, as the sensor in the target camera component has a pattern noise during imaging, and the pattern noise may be a PRNU noise, the photographed target image correspondingly includes the pattern noise.

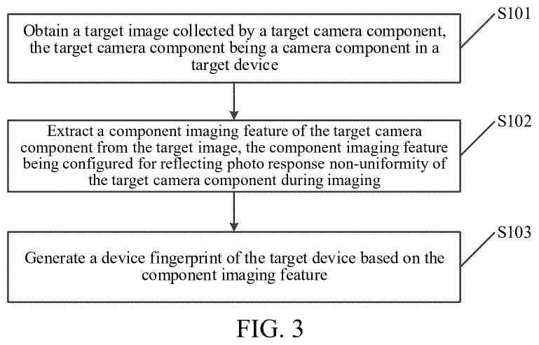

The server 200 may obtain the foregoing target image (for example, the target image may be photographed by using the target camera component and provided to the server 200 after the target camera component is produced). Further, the server 200 may extract an imaging feature of the target camera component from the target image. The imaging feature may be the PRNU noise generated by the sensor in the target camera component. The imaging feature may be referred to as a component imaging feature, and the component imaging feature may be configured for reflecting a photo response non-uniformity of the target camera component. For a specific process of extracting the component imaging feature from the target image, refer to descriptions in the following embodiment corresponding to FIG. 3.

Further, the server 200 may generate the device fingerprint of the target device based on the foregoing component imaging feature. Subsequently, the server 200 may accurately identify and verify an identity of the target device based on the generated device fingerprint of the target device. For a specific process, refer to related descriptions in the following embodiments.

In this disclosure, as the component imaging feature of the target device is an inherent imaging feature of the target camera component in the target device, an accurate and stable device fingerprint can be generated for the target device based on the component imaging feature.

Referring to FIG. 3, FIG. 3 is a schematic flowchart of a device data processing method according to this disclosure. An execution body in this embodiment of this disclosure may be a device data processing device (which may be referred to as a data processing device). The data processing device may be a computer device, or a computer device cluster including a plurality of computer devices. The computer device may be a server, a terminal device, or another device, which is not limited. As shown in FIG. 3, the method may include the following operations:

Operation S101: Obtain a target image collected by a target camera component, the target camera component being a camera component in a target device.

The target device may have a camera component, and the camera component in the target device may be referred to as a target camera component. The target device may be a terminal device or another device. For example, the target device may be a POS machine of a merchant, a handheld terminal device of a user, a portable terminal device, or the like. The target camera component may be a component in the target device and is configured to photograph an image. For example, the target camera component may be a camera in the target device, and the camera has a sensor. In an embodiment, the target device may be an Internet of Things device (IoT device).

The data processing device may obtain a target image collected (for example, photographed) by the target camera component. The target image may be any image collected by the target camera component. In an embodiment, the target image may be a picture photographed by the target device, or the target image may be a video frame selected from a video filmed by the target camera component. Subsequently, the data processing device may generate the device fingerprint of the target device based on the target image.

In an embodiment, the target image may be obtained through photographing by the target camera component when the target camera component is delivered from a factory or when the target camera component is assembled into the target device. In this case, the device fingerprint of the target device is pre-generated before the target device is put into service, and is subsequently configured for identifying the target device.

Alternatively, the target image may be collected by calling the target camera component in the target device when the target device, after being put into service, needs to be identified by using the device fingerprint of the target device. Herein, calling the target camera component to photograph an image is performed with permission of a user of the target device. For example, a query pop-up window may be displayed, and the user may click an agree option in the query pop-up window, and then the target camera component may be called to photograph an image or a video. The target device may send the photographed image to the data processing device.

Operation S102: Extract a component imaging feature of the target camera component from the target image, the component imaging feature being configured for reflecting photo response non-uniformity of the target camera component during imaging.

The data processing device may extract a component imaging feature of the target camera component from the target image. The component imaging feature may be a PRNU feature extracted from the target image. The component imaging feature may be configured for reflecting photo response non-uniformity of the target camera component during imaging. As the PRNU feature is generated due to uneven thickness of a silicon coating of a photosensitive element of the target camera component at each position, the PRNU feature is an inherent feature of the target camera component.

In some aspect, PRNU features included in different images photographed by the same camera component are the same. Even if the PRNU features included in different images photographed by the same camera component are different, a difference is very subtle and may be ignored. Therefore, the PRNU features included in different images photographed by the target camera component may be considered to be the same.

The following describes a specific process of extracting the component imaging feature of the target camera component from the target image.

First, a formula is introduced to describe the PRNU features. The formula obtains a PRNU noise (that is, the PRNU feature) based on a noise extraction method of wavelet filtering, and in the formula, an image is considered as a compound of a noise-free image and a noise image. The formula is as below:

$${y}_{ij} = {f}_{ij} ( {x}_{ij} + {η}_{ij} ) + {c}_{ij} + {ϵ}_{ij} \qquad ( 1 )$$

In the formula, i represents a quantity of rows, j represents a quantity of columns, i is a positive integer less than or equal to a total quantity of rows of silicon coatings of the target camera component, and j is a positive integer less than or equal to a total quantity of columns of the silicon coatings of the target camera component. fᵢⱼ is configured for determining a PRNU multiplicative noise factor of a pixel position at the i^{th} row and the j^{th} column of the silicon coating of the target camera component, and fᵢⱼ may be a noise function related to the PRNU noise. yᵢⱼ may represent an overall noise signal of an image defined by using the foregoing formula.

A size (which may be understood as an area) of the silicon coating of the target camera component is equal to a size of an image photographed by the target camera component. Therefore, a pixel position of the silicon coating of the target camera component corresponds to a pixel point position of the target image. For example, a pixel position of the silicon coating of the target camera component at the i^{th} row and the j^{th} column corresponds to a pixel point position of the target image at the i^{th} row and the j^{th} column. Therefore, the PRNU multiplicative noise factor of the pixel position at the i^{th} row and the j^{th} column of the silicon coating of the target camera component may be the PRNU multiplicative noise factor of the pixel point at the i^{th} row and the j^{th} column of the target image.

xᵢⱼ represents incident illumination of a sensor (which may be a photosensitive element) of the target camera component, nᵢⱼ represents a shot noise. The shot noise is a PRNU-related noise, and is a noise caused by electron emission non-uniformity (caused by uneven thickness of the silicon coating). The shot noise may also be referred to as an ambient noise.

cᵢⱼ represents a dark current noise. The dark current noise is a noise caused by a current when the target camera component photographs an image, and is usually fixed. The dark current noise is a noise feature of the target camera component when the target camera component is delivered from a factory. ϵᵢⱼ represents an additional random noise. The additional random noise is a small noise added to balance noises, and may be a fixed value. The additional random noise may exist, or may not exist. The dark current noise and the additional random noise are not noises related to the PRNU noise.

Therefore, in this disclosure, the fᵢⱼ(xᵢⱼ+ηᵢⱼ) part of noise needs to be kept, and the cᵢⱼ+ϵᵢⱼ part of noise needs to be removed.

Based on the foregoing described principle, the specific process of extracting the component imaging feature of the target camera component from the target image in this disclosure may be described by using the following content.

First, the data processing device may perform signal decomposition processing on the target image, to obtain a noise signal (which may be referred to as an image noise signal) and a non-noise signal included in the target image. The data processing device may perform the signal decomposition processing on the target image by using a wavelet transform method (for example, four-level wavelet transform). In an embodiment, a wavelet basis of the wavelet transform may be db4 (a wavelet function, which may be configured for determining a waveform of the wavelet transform) by default, or may be another wavelet basis based on different actual application scenarios.

As the dark current noise and the additional random noise are generally noises of a low-frequency signal, in this disclosure, a low-frequency signal in the image noise signal obtained by decomposition may be removed, to obtain a transition noise signal, that is, a noise signal obtained by removing the low-frequency signal in the image noise signal may be referred to as the transition noise signal. In this way, a noise of the useless low-frequency signal is removed, helping to determine a more accurate and stable component imaging feature based on the transition noise signal obtained thereby.

The low-frequency signal may be a signal whose signal frequency is lower than a set frequency threshold, and the low-frequency signal is a signal that occurs less frequently in the image noise signal. The frequency threshold may be set based on an actual application scenario.

The foregoing transition noise signal may include noise signals of a plurality of parts obtained through wavelet transform decomposition. The noise signals of the plurality of parts may include noise signals of the target image in a plurality of directions (which may be referred to as reference directions). In an embodiment, the plurality of reference directions may include a horizontal direction, a vertical direction, a diagonal direction, and the like.

In other words, as the low-frequency signal (which may be referred to as a low-frequency component) in the image noise signal has been removed, the transition noise signal may include a high-frequency noise component (which may also be referred to as a high-frequency noise signal) in a horizontal direction, a high-frequency noise component in a vertical direction, and a high-frequency noise component in a diagonal direction. The foregoing image noise signal may also include noise signals in the plurality of reference directions (the noise signal in each reference direction may include a low-frequency noise signal and a high-frequency noise signal).

The target image may include images (which may be understood as image components of the target image on a plurality of channels) on a plurality of channels (for example, may include three channels: R (a red color channel), G (a green color channel), and B (a blue color channel)). Therefore, the foregoing process of performing the signal decomposition processing on the target image, to obtain an image noise signal included in the target image may include: separately performing the signal decomposition processing (for example, wavelet transform processing) on image components of the target image on each channel, to obtain an image noise signal of the target image on each channel, where one channel may have one foregoing image noise signal.

Subsequently, the component imaging feature of the target camera component may be generated based on the image noise signal of the target image on each channel. As principles of processing the image components on the channels are the same and independent, a process of processing an image noise signal on any channel is used as an example for description below.

The noise signal in each reference direction included in the foregoing transition noise signal may correspond to a signal intensity coefficient. The signal intensity coefficient may be configured for reflecting intensity of the noise signal in the corresponding reference direction. A noise signal in one reference direction may correspond to one signal intensity coefficient. A larger signal intensity coefficient indicates higher intensity of the noise signal. Otherwise, a smaller signal intensity coefficient indicates lower intensity of the noise signal.

The signal intensity coefficient corresponding to the noise signal in each reference direction in the transition noise signal may alternatively be generated by performing the signal decomposition processing on the target image. The signal intensity coefficient corresponding to the noise signal in each reference direction may be a wavelet coefficient in each reference direction obtained by performing the signal decomposition processing on the target image. In other words, a signal intensity coefficient in a reference direction may be a wavelet coefficient obtained through decomposition in the reference direction. A wavelet coefficient of a noise signal in a reference direction may be configured for reflecting a similarity between a waveform of the noise signal in the reference direction and a waveform of wavelet transform. A larger wavelet coefficient indicates a larger similarity between the waveform of the noise signal in the reference direction and the waveform of the wavelet transform. Otherwise, a smaller wavelet coefficient indicates a smaller similarity between the waveform of the noise signal in the reference direction and the waveform of the wavelet transform.

The data processing device may perform denoising processing on the obtained signal intensity coefficients corresponding to the noise signals in the plurality of reference directions, to obtain denoised signal intensity coefficients in the reference direction. Further, the data processing device may generate the foregoing component imaging feature by using the denoised signal intensity coefficients in the plurality of reference directions included in the transition noise signal.

In an embodiment, a process of performing denoising processing, by the data processing device, on the signal intensity coefficients corresponding to the noise signals in the plurality of reference directions may include the following operations:

Any one of the plurality of reference directions may be used as a target reference direction. Descriptions are provided below by using an example in which the denoising processing is performed on a signal intensity coefficient corresponding to a noise signal of a transition noise signal on one channel (which may be any one) in a reference direction.

In an embodiment, a signal intensity coefficient (that is, a wavelet coefficient) corresponding to a noise signal in the target reference direction may be a vector (which may be referred to as a coefficient vector). The vector may include a plurality of values (that is, a plurality of elements), and the plurality of values may be referred to as a plurality of coefficient values (that is, values of coefficients of the wavelet transform) included in the signal intensity coefficient. In other words, the signal intensity coefficient corresponding to the noise signal in the target reference direction may include the plurality of coefficient values.

The data processing device may perform variance estimation (which may be local variance estimation) on the plurality of coefficient values in the signal intensity coefficient of the noise signal in the target reference direction (which may be briefly referred to as the signal intensity coefficient in the target reference direction), to obtain an estimated variance value in the target reference direction. The local variance estimation may be implemented by using an initial standard deviation, and a default value of the initial standard deviation may be 5 (or may be another value).

A process of performing the local variance estimation on the signal intensity coefficient in the target reference direction may include the following operations:

The data processing device may obtain a target window (which is a sliding window), and the target window is a window used when the local variance estimation is performed on the signal intensity coefficient in the target reference direction. The target window has a set window size (which may be set based on an actual application scenario, for example, may be set to 3, 5, 7, or 9). Further, sliding estimation may be performed on the plurality of coefficient values in the signal intensity coefficient in the target reference direction by using the target window. A sliding step length may also be determined based on an actual application scenario, and for example, may be 1 or 3.

Each time the target window is slid, a coefficient value, whose quantity is the foregoing window size in the signal intensity coefficient in the target reference direction, may be selected. The target window may be slid for a plurality of times based on the step length, so that finally all coefficient values in the signal intensity coefficient in the target reference direction are selected. Each time the target window completes sliding, the data processing device may perform the variance estimation on the coefficient value selected by the target window, to obtain an estimated variance value of the coefficient value selected by the target window. One sliding position may correspond to one estimated variance value. Further, a minimum estimated variance value in estimated variance values respectively corresponding to a plurality of sliding positions can be used as an estimated variance value in the target reference direction.

For example, if the signal intensity coefficient in the target reference direction includes nine coefficient values (sequentially being a coefficient value 1 to a coefficient value 9), a size of the target window is 3, and the step length is 3, when the target window is at a start position, the coefficient value 1 to the coefficient value 3 may be selected from the nine coefficient values by using the target window, and the variance estimation may be performed on the coefficient value 1 to the coefficient value 3, to obtain an estimated variance value 1. Further, the target window is slid rightwards by three coefficient values (because the step length is 3), so that the coefficient value 4 to the coefficient value 6 are selected from the nine coefficient values by using the target window, and the variance estimation may be performed on the coefficient value 4 to the coefficient value 6, to obtain an estimated variance value 2. Then, the data processing device further slides the target window rightwards by three coefficient values, so that the coefficient value 7 to the coefficient value 9 are selected from the nine coefficient values in the target window, and the variance estimation may be performed on the coefficient value 7 to the coefficient value 9, to obtain an estimated variance value 3. Finally, a minimum estimated variance value of the estimated variance value 1, the estimated variance value 2, and the estimated variance value 3 obtained through the foregoing estimation may be used as the estimated variance value in the target reference direction.

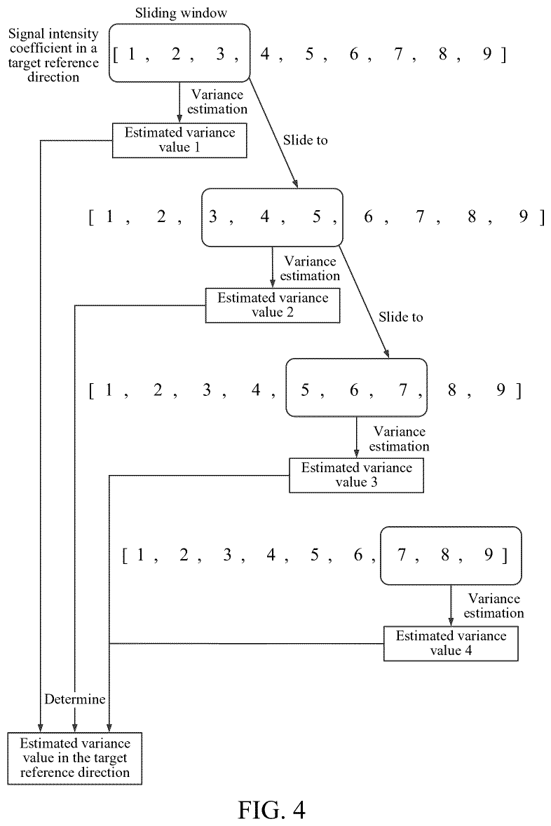

Referring to FIG. 4, FIG. 4 is a schematic diagram of a scene of variance estimation according to this disclosure. As shown in FIG. 4, the signal intensity coefficient in the target reference direction may have a total of nine coefficient values: coefficient values 1 to 9. The sliding window herein may be the foregoing target window. A step length of the target window herein may be 2, and a window size may be 3.

When the sliding window is at the start position, the coefficient value 1 to the coefficient value 3 in the signal intensity coefficient in the target reference direction may be selected, and the variance estimation is performed on the coefficient value 1 to the coefficient value 3, to obtain an estimated variance value 1. Further, the sliding window is slid rightwards by two coefficient values, the coefficient value 3 to the coefficient value 5 in the signal intensity coefficient in the target reference direction may be selected, and the variance estimation is performed on the coefficient value 3 to the coefficient value 5, to obtain an estimated variance value 2. Then, the sliding window is slid rightwards by two coefficient values again, the coefficient value 5 to the coefficient value 7 in the signal intensity coefficient in the target reference direction may be selected, and the variance estimation is performed on the coefficient value 5 to the coefficient value 7, to obtain an estimated variance value 3. Further, the sliding window is slid rightwards by two coefficient values again, the coefficient value 7 to the coefficient value 9 in the signal intensity coefficient in the target reference direction may be selected, and the variance estimation is performed on the coefficient value 7 to the coefficient value 9, to obtain an estimated variance value 4. Hereto, the variance estimation has been performed on all coefficient values included in the signal intensity coefficient in the target reference direction.

The data processing device may use a minimum value of the obtained estimated variance value 1, estimated variance value 2, estimated variance value 3, and estimated variance value 4 as the estimated variance value in the target reference direction.

After the estimated variance value in the target reference direction is obtained, denoising processing may be performed by using the signal intensity coefficient of the noise signal in the target reference direction, to obtain a denoised signal intensity coefficient in the target reference direction. In an embodiment, the process may include: inputting the signal intensity coefficient and the estimated variance value in the target reference direction to a filter (such as a Wiener filter) configured to denoise a coefficient, and further, performing, by the filter, the denoising processing on the signal intensity coefficient in the target reference direction based on the estimated variance value, to obtain the denoised signal intensity coefficient in the target reference direction.

The Wiener filter may perform filtering (that is, denoising) on the signal intensity coefficient in the target reference direction, to obtain a signal intensity coefficient after denoising, and a variance value of the signal intensity coefficient after denoising may be close to an inputted estimated variance value. In this way, an interference signal in the signal intensity coefficient in the target reference direction can be filtered out, to obtain a signal intensity coefficient that tends to be stable.

By using the foregoing described implementation, the data processing device can perform the denoising processing on the signal intensity coefficient of the noise signal in each reference direction in the transition noise signal of each channel, to obtain a denoised signal intensity coefficient corresponding to the noise signal in each reference direction in the transition noise signal of each channel.

Through the foregoing denoising processing on the signal intensity coefficient in each reference direction, a coefficient value with a sudden change (for example, a sudden change to high or a sudden change to low) in the signal intensity coefficient in each reference direction can be removed, to obtain a more accurate and stable signal intensity coefficient. Through the denoising processing on the signal intensity coefficient in each reference direction, a noise signal with a large sudden change in the foregoing incident illumination noise xᵢⱼ and shot noise nᵢⱼ can also be removed, so that a more steady and stable component imaging feature may also be obtained subsequently (that is, the denoising processing on the signal intensity coefficient may be understood as the denoising processing on an initial component imaging feature).

Further, a denoised noise signal in each reference direction can be obtained by using the foregoing denoised signal intensity coefficient (including denoised signal intensity coefficients on all channels) in each reference direction. For example, the denoised signal intensity coefficient and a wavelet (which is a basic element of wavelet transform and is configured for representing a signal) can be combined to generate a denoised noise signal. The wavelet may be understood as a musical note in an audio scene, and the denoised signal intensity coefficient may be understood as a tone of the musical note in the audio scene.

In an embodiment, the data processing device may separately perform inverse transform of decomposition (for example, an inverse transform method of a wavelet transform method, that is, inverse wavelet transform) on the foregoing denoised noise signal in each reference direction, to generate a noise image in each reference direction, and further perform fusion processing on noise images in the plurality of reference directions, to obtain a final component imaging feature. The component imaging feature may be an image or may be a PRNU feature image. In other words, the inverse transform of decomposition may be performed on the denoised noise signal in each reference direction by using an inverse wavelet transform method.

Alternatively, in an embodiment, the data processing device may first perform signal fusion (for example, superposition) on denoised noise signals in the reference directions, to generate a fused denoised signal. Further, the data processing device may perform the inverse transform of decomposition (for example, the inverse transform method of the wavelet transform method, that is, the inverse wavelet transform) on the fused denoised signal, to generate a final component imaging feature.

Component imaging features generated in the foregoing two manners are the same. In some aspect, how to generate a component imaging feature based on denoised signals in the foregoing plurality of reference directions may be determined based on an actual application scenario.

In an embodiment, the inverse transform of decomposition may be directly performed on the denoised noise signal in each reference direction based on the foregoing manner, to obtain the noise image in each reference direction. Then, the fusion processing is performed on noise images in the reference directions, and a noise image obtained thereof is used as the component imaging feature of the target device.

Alternatively, in this disclosure, the inverse transform of decomposition may be performed on the denoised noise signal in each reference direction, to obtain the noise image in each reference direction, and then a noise image obtained by fusing noise images in the reference directions is used as an initial component imaging feature of the target device. To further filter out a noise other than a PRNU feature in the initial component imaging feature, in this disclosure, noise filtering (such as zero-mean filtering) may be performed on the initial component imaging feature (which belongs to an image), to obtain a more accurate component imaging feature of the target device.

In this way, by using the foregoing manner, the inverse transform of decomposition (for example, the inverse transform of decomposition is performed based on the inverse transform method of the wavelet transform method) is performed on the denoised noise signal in each reference direction, to obtain the noise image in each reference direction, and then the noise images in the reference directions are fused to obtain a component imaging feature. This can ensure that the generated component imaging feature does not include useless noise information, that is, ensure that the generated component imaging feature is accurate and stable and can uniquely represent the target device.

In an embodiment, sizes of images photographed by different camera components may be different. Therefore, to generate component imaging features of various camera components by using a unified method, in this disclosure, the images photographed by the camera components may be uniformly cropped according to a unified image cropping rule, to generate the component imaging features of the camera components by using cropped images.

Therefore, in this disclosure, the image cropping rule may further be obtained, and the target image may be cropped (images of the target image on three channels: the R channel, the G channel, and the B channel may be separately cropped) based on the image cropping rule, to obtain a cropped image of the target image (which may include cropped images of the target image on the R channel, the G channel, and the B channel). Further, the component imaging feature of the target camera component may be extracted from the cropped image. For example, in the foregoing process of performing signal decomposition processing on the target image to obtain the image noise signal included in the target image, the image noise signal may be obtained by performing the signal decomposition processing on the cropped image of the target image, that is, the image noise signal may be a noise signal of the cropped image of the target image.

In an embodiment, the image cropping rule may be configured for defining a size and a position for cropping an image. The size for cropping may be set based on an actual application scenario, for example, may be a size of (224, 224) (a size of the cropped image of the target image may be (224, 224, 3), indicating that sizes of the cropped images on the three channels are all (224, 224)). The position for cropping may also be set based on an actual application scenario, for example, the position for cropping may be a center position of the target image, and therefore, the cropped image of the target image obtained through cropping may be an image having the foregoing cropping size at the center position of the target image.

In this way, before the component imaging feature is extracted, the target image is preprocessed, to crop out a cropped image having a particular size from a particular position in the target image. Then, the component imaging feature is extracted based on the cropped image, helping to standardize an extraction procedure of the component imaging feature, and to ensure accuracy and stability of the extracted component imaging feature.

The generated component imaging feature can be configured for reflecting a noise pattern when the target device photographs an image.

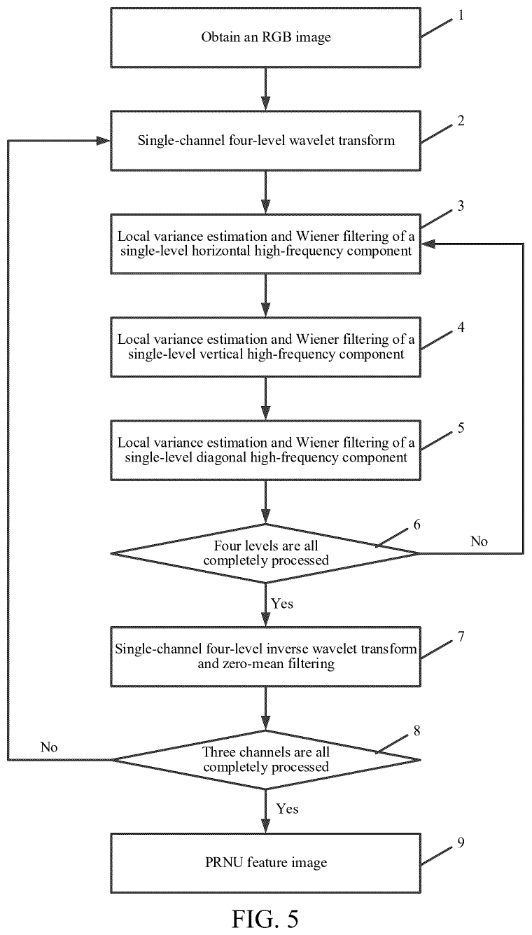

Referring to FIG. 5, FIG. 5 is a schematic flowchart of a feature extraction method according to this disclosure. As shown in FIG. 5, the procedure may include the following operations:
1. The data processing device obtains an RGB image (an image of the three color channels), and the RGB image may be a cropped image of the foregoing target image.
2. The data processing device performs single-channel (any one of the three color channels) four-level wavelet transform on the RGB image. The four-level wavelet transform refers to performing multi-dimensional (four-dimensional herein) wavelet transform on the RGB image. Wavelet bases of the wavelet transform in different dimensions may be different. Therefore, after performing the wavelet transform in different dimensions on a signal, different signal intensity coefficients of the signal may be obtained through decomposition. Principles of performing the wavelet transform on the signal in the dimensions are the same and independent. The multi-dimensional wavelet transform is performed on the signal (such as the foregoing RGB image), so that the signal can be decomposed and represented in multiple dimensions, and a more accurate PRNU feature can be obtained subsequently.
3. Perform local variance estimation and Wiener filtering on a horizontal high-frequency component (for example, a noise signal in a horizontal direction in the foregoing transition noise signal) of a single level (a single level refers to any level in the four-level wavelet transform) in the foregoing four-level wavelet transform, to obtain a denoised signal intensity coefficient in the horizontal direction of the single level.
4. Perform the local variance estimation and the Wiener filtering on a vertical high-frequency component (for example, a noise signal in a vertical direction in the foregoing transition noise signal) of the foregoing single level, to obtain a denoised signal intensity coefficient in the vertical direction of the single level.
5. Perform the local variance estimation and the Wiener filtering on a diagonal high-frequency component (for example, a noise signal in a diagonal direction in the foregoing transition noise signal) of the foregoing single level, to obtain a denoised signal intensity coefficient in the diagonal direction of the single level.
6. Determine whether processing of the noise signal (such as the transition noise signal) on the foregoing four levels is completed, that is, determine whether the denoised signal intensity coefficient in each reference direction of each level is obtained. If the processing is completed, the following operation 7 may be performed. If the processing is not completed, the foregoing operation 3 may be performed again, to perform denoising processing on a signal intensity coefficient corresponding to a noise signal in each reference direction on a next level.
7. Perform inverse wavelet transform and zero-mean filtering processing on the denoised noise signal in each reference direction on the foregoing single channel (for example, any one of the foregoing three color channels), to generate a noise image on the single channel.
8. Determine whether noise images on the three color channels are obtained. If the noise images on the three color channels are obtained, perform the following operation 9. If the noise images on the three color channels are not obtained, perform the foregoing operation 2 and operations afterwards again, and then obtain a noise image on a next channel based on the foregoing procedure.
9. A final PRNU feature image (that is, a component imaging feature) can be generated by using the noise images on the three color channels. For example, the fusion processing may be separately performed on noise images on each color channel in the plurality of reference directions, to obtain a fused noise image on each color channel, and a finally obtained component imaging feature may include the fused noise image on each color channel.

Operation S103: Generate a device fingerprint of the target device based on the component imaging feature.

In an embodiment, the data processing device may use any one of the following manners to generate the device fingerprint of the target device by using the foregoing component imaging feature of the target camera component extracted from the target image.

The data processing device may directly use the component imaging feature as the device fingerprint of the target device.

The data processing device may obtain a local feature from the component imaging feature, and use the local feature as the device fingerprint of the target device. For example, the data processing device may capture a local image from the component imaging feature, and use the local image as the device fingerprint of the target device.

The data processing device may alternatively fuse some device attribute information of the target device with the component imaging feature, to generate the device fingerprint of the target device. For example, the device attribute information of the target device may include a hardware address (a mac address), a device identifier, a device type, or the like of the target device. Based on the device attribute information of the target device, an attribute image of the target device may be generated. For example, the attribute image may include text of the attribute information of the target device, and a size of the attribute image may be the same as a size of the component imaging feature. Further, the data processing device may superpose the attribute image and the component imaging feature of the target camera component (for example, adding pixel values at the same pixel position), to generate the device fingerprint of the target device.

In the foregoing manner of this disclosure, a specific and stable device fingerprint of the target device can be generated by using the imaging feature (such as the PRNU feature) of the target camera component in the target device. The device fingerprint may be subsequently used in any scenario in which the target device needs to be identified, for example, may be applied to a scenario in which device identification and verification are performed on the target device by using the device fingerprint.

The foregoing device fingerprint generation method of this disclosure has the following advantages: First, as a device can easily collect an image, and a calculation amount of extracting PRNU features from a target image is small, a device fingerprint of the device can be generated more conveniently. Second, as PRNU features of various camera components are inherent and unique, the device fingerprint generated based on the PRNU features may enable different camera components to have high distinguishing precision. Third, as the PRNU features are strongly related to a photosensitive element of the camera components, the device fingerprint generated based on the PRNU features has good stability.

In this disclosure, a target image collected by a target camera component can be obtained, the target camera component being a camera component in a target device; a component imaging feature of the target camera component can be extracted from the target image, the component imaging feature being configured for reflecting photo response non-uniformity of the target camera component during imaging; and further, a device fingerprint of the target device can be generated based on the component imaging feature. Based on the method provided in this disclosure, the device fingerprint of the target device can be generated based on the component imaging feature of the target camera component in the target device. The component imaging feature is configured for reflecting the exclusive and inherent photo response non-uniformity of the target camera component, and has high uniqueness and stability, therefore, the device fingerprint of the target device that has a strong binding and association relationship with the target camera component is generated based on the component imaging feature, ensuring that the device fingerprint is stable, and can be configured for accurately identifying a target device having the target camera component.

Referring to FIG. 6, FIG. 6 is a schematic diagram of a scene of a network training method according to this disclosure. As shown in FIG. 6, the method may include the following operations:

Operation S201: Obtain a to-be-trained device classification network.

In an embodiment, the data processing device may obtain a to-be-trained device classification network, and the to-be-trained device classification network may be a neural network model configured for classifying a device based on a device fingerprint of the device.

In an embodiment, the device classification network in this disclosure may be state-of-the-art (SOTA) (target identification) EfficientNet-B4 (a high-efficient convolutional neural network), and certainly, may alternatively be another network structure, which is not limited in the embodiment of this disclosure.

Operation S202: Call the device classification network, and determine, based on the device fingerprint of the target device, a predicted device type corresponding to the target device.

In an embodiment, a quantity of target devices is multiple, and one target device may have one related device type. A device type related to the target device is an actual device type (that is, a real device type) of the target device. In a process of training the device classification network, the device type related to the target device may be used as a label for model training. A plurality of target devices may be related to a plurality of device types in total, and classification training may be performed on the foregoing to-be-trained device classification network by using the target devices of the plurality of device types, so that the to-be-trained device classification network may subsequently identify the plurality of device types. The plurality of target devices have no one-to-one correspondence with the plurality of device types, that is, there may be at least two target devices corresponding to the same device type.

In an embodiment, to enable the to-be-trained device classification network to more evenly and accurately learn features of the plurality of device types, quantities of target devices of the foregoing various device types may be even. For example, the quantities of target devices of the device types may be the same, or an absolute value of a difference between quantities of target devices of any two device types is less than or equal to a target value, and the target value may be a small value (which may be a positive integer).

The data processing device may call the to-be-trained device classification network, and separately predict a device type of each target device based on a device fingerprint (the device fingerprint obtained by using the foregoing component imaging feature) of each target device, that is, obtain a predicted device type corresponding to each target device. One target device may correspond to one predicted device type. For any target device, a predicted device type corresponding to the target device is any one of the plurality of device types of the foregoing plurality of target devices.

In an embodiment, the data processing device calls the to-be-trained device classification network, and the determined predicted device type corresponding to the target device may be represented by using a vector (which may be probability distribution and may be referred to as a predicted classification probability). The vector may include a probability that the predicted device type of the target device is each of the foregoing plurality of device types, and the predicted device type corresponding to the target device may be a device type corresponding to the largest probability in the vector.

Operation S203: Modify, based on a difference between the predicted device type corresponding to the target device and the device type related to the target device, a network parameter of the device classification network.

The data processing device may modify, based on a difference between the predicted device type corresponding to the target device and the device type related to the target device, a network parameter of the to-be-trained device classification network. The process may include the following operations:

The data processing device may generate, based on the predicted device type corresponding to the target device and the device type related to the target device, a device classification loss (which may include a sum of device classification losses for the target devices) of the device classification network for the target device. The device classification loss may be configured for indicating the difference between the predicted device type corresponding to the target device and the device type related to the target device. A larger device classification loss indicates a larger difference between the predicted device type corresponding to the target device and the device type related to the target device. Otherwise, a smaller device classification loss indicates a smaller difference between the predicted device type corresponding to the target device and the device type related to the target device.

For example, the device type related to the target device may alternatively be represented by using a vector (which may be referred to as a real classification probability). In the vector, only a probability value corresponding to a device type related to the target device is 1, and probability values corresponding to other device types are 0. Therefore, in an embodiment, a classification loss for one target device may be a cross-entropy loss between the real classification probability and the predicted classification probability of the target device for the foregoing plurality of device types.

The data processing device may modify the network parameter of the foregoing to-be-trained device classification network by using the foregoing obtained device classification loss for the target device. After modification of the network parameter of the to-be-trained device classification network is completed, a trained device classification network may be obtained. An objective of modifying the network parameter of the to-be-trained device classification network is to make the foregoing device classification loss tend to a minimum value (for example, tend to 0).

In an embodiment, that the modification of the network parameter of the to-be-trained device classification network is completed may mean that the network parameter of the to-be-trained device classification network is modified to a convergence state, or may mean that a quantity of times of performing iterative training on the network parameter of the to-be-trained device classification network based on the foregoing principle reaches (is greater than or equal to) a times threshold.

Referring to FIG. 7, FIG. 7 is a schematic diagram of a scene of network training according to this disclosure. As shown in FIG. 7, the data processing device may input the device fingerprint of the target device to the to-be-trained device classification network, and the to-be-trained device classification network may determine the predicted device type corresponding to the target device based on the inputted device fingerprint.

Further, the data processing device may generate, based on the difference between the predicted device type corresponding to the target device and the device type related to the target device, a classification loss (that is, the foregoing device classification loss) of the to-be-trained device classification network for the target device. Further, the data processing device may back propagate the device classification loss to the to-be-trained device classification network, and modify the network parameter of the to-be-trained device classification network by using the device classification loss, to obtain the trained device classification network.

The foregoing trained device classification network may be subsequently configured for classifying a device type of a device based on a device fingerprint of the device. In an embodiment, camera components in target devices belonging to the same device type are usually produced in the same batch based on the same method, and the camera components generated in the batch usually have the same imaging feature. For example, the camera components generated in the batch may be camera components in the same batch of POS machines.

In this way, by using the foregoing manner, by training a device classification network configured for identifying a device type based on a device fingerprint, application scenarios of a device fingerprint determined by using the method provided in the embodiments of this disclosure can be extended, so that the device fingerprint can be used in a device classification scenario. Through the trained device classification network, a type of a device is accurately determined based on a device fingerprint generated by using a component imaging feature, thereby improving device classification accuracy.

A process of performing verification and identification on a device by using the trained device classification network is described below by using an example.

The data processing device may obtain a verification image sent by a verification device. The verification device may be a front-end device, for example, the verification device may be a POS machine. The verification image may be an image photographed by the verification device by calling a camera component in the verification device. For example, the verification image may be photographed when the verification device requests the data processing device to call a target service (which may be any service, and may be determined based on an actual application scenario, for example, may be a device service for the entire verification device, or a service for an application program in the verification device), or may be an image photographed by the verification device that is requested by the data processing device after the verification device requests the data processing device to call the target service, or may be an image actively photographed and sent to the data processing device by the verification device.

For example, if the verification device is the POS machine, the verification image may be an image photographed in real time by the verification device after the POS machine initiates a request for calling a POS service to the data processing device, or when the POS machine initiates the request for calling the POS service to the data processing device. The verification device may have a program that can photograph an image in real time, and the data processing device may also have an interface for receiving an image photographed in real time. Therefore, the data processing device can securely and correctly receive, through the interface, a verification image photographed by the verification device in real time, that is, a received verification image can be ensured to be photographed by the verification device in real time.

The data processing device generates, based on the foregoing received verification image and the foregoing principle of generating a device fingerprint of a target device, a device fingerprint of the verification device.

Further, the data processing device may call the trained device classification network to determine, based on the device fingerprint of the verification device, a target device type corresponding to the verification device in the plurality of device types, and may use a device type in the plurality of device types that has the largest probability predicted for the verification device and is greater than a probability threshold as a target device type predicted for the verification device.

The foregoing plurality of device types respectively have related device services. A device service related to a device type may refer to a device service that a device of the device type can call, that is, the device may have authorization to call the device service related to the device type to which the device belongs.

Therefore, if the verification device initiates a call request for the target device service, for example, the verification device sends the call request for the target device service before sending the foregoing verification image, or sends the call request for the target device service together with the foregoing verification image, and if a requested target device service is consistent with (that is, the same as) the device service related to the target device type to which the verification device belongs, the data processing device may provide the target device service to the verification device in response to the call request, for example, provide a POS service to the verification device.

Even in some special cases, for example, when the device fingerprint of the verification device is leaked, by using the method provided in this disclosure, the device type (a device identity) of the device can still be securely and accurately identified by using an image photographed in real time. The data processing device does not directly receive the device fingerprint, that is, does not directly verify the received device fingerprint, but receives an image photographed by the verification device in real time, and further verifies the device fingerprint generated based on the image. Therefore, even if the device fingerprint of the verification device is leaked in advance, a PRNU feature specific to the verification device cannot be added to another image and then provided to the data processing device. In addition, verifying the image photographed in real time further eliminates a possibility of forging a local image including a PRNU feature specific to the target device to the data processing device, to skip identity identification of the target device. Therefore, by using the method provided in this disclosure, the identity of the device including the target camera component can be securely and accurately identified based on a component imaging feature of the target camera component.

By using the foregoing method of this disclosure, the device fingerprint, generated by the device classification network based on the component imaging feature of the camera component in the device, can be called to accurately and automatically identify the identity (that is, the type) of the device, and further, subsequent service processing (for example, processing related to a device service related to the device type of the verification device) can be performed on the verification device based on an identification result. In this way, a corresponding target device service is provided to the verification device based on the device type identification result of the verification device, to ensure that an applicable device service is provided to the corresponding device, thereby improving security of the device service.

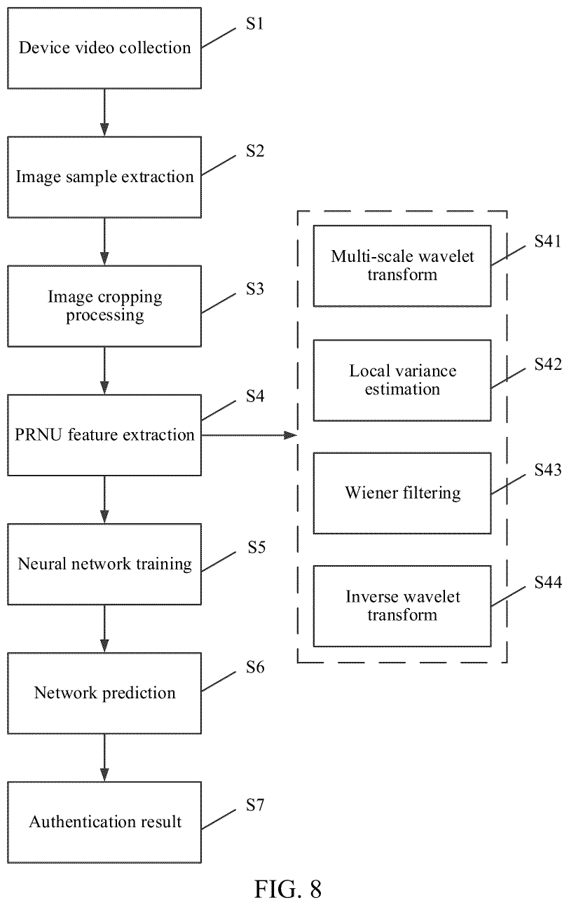

Referring to FIG. 8, FIG. 8 is a schematic flowchart of performing device classification based on a device fingerprint according to this disclosure. A procedure of an entire solution of this disclosure is described in a corresponding embodiment of FIG. 8. As shown in FIG. 8, the procedure may include the following operations:
S1: The data processing device may collect a device video, and the device video may be a video photographed (that is, collected) by the target device by calling a target camera component included in the target device.
S2: The data processing device may sample and extract the device video, that is, sample (may be random sampling, or may be uniform sampling (for example, video frames are sampled at an interval of the same quantity of video frames)) a plurality of video frames from the device video, to perform subsequent network training, and the video frames obtained through sampling may be used as the foregoing target image.
S3: The data processing device may perform image cropping on the sampled target image, for example, perform cropping according to the image cropping rule, to obtain a cropped image of the target image.
S4: The data processing device may extract a PRNU feature (that is, a component imaging feature) of the target camera component in the target device from the cropped image of the target image, and may generate a device fingerprint of the target device based on the PRNU feature.

Operation S4 may include operations S41 to S44. Operation S41: The data processing device may perform multi-scale (for example, the foregoing four-level) wavelet transform on the cropped image of the target image. Operations S42 and S43: The data processing device may perform local variance estimation and Wiener filtering on a result of the multi-scale wavelet transform, to obtain a denoised noise signal of the cropped image. Operation S44: The data processing device may perform inverse wavelet transform on the denoised noise signal, to obtain the PRNU feature of the target camera component in the target device.
S5: The data processing device may train a neural network based on the foregoing generated device fingerprint of the target device, for example, train the foregoing to-be-trained device classification network, to obtain a trained device classification network.
S6: The data processing device may perform network prediction by using the foregoing trained device classification network, for example, predict a device type of the verification device based on the device fingerprint of the verification device by using the foregoing trained device classification network.
S7: The data processing device may authenticate the verification device based on the device type predicted by the verification device by using the trained device classification network, for example, authenticate whether the verification device has authorization to call the currently initiated target service, and then obtain an authentication result for verification. If the authentication result is configured for indicating that the verification device has the authorization to call the currently initiated target service, the data processing device can provide the target service to the verification device.

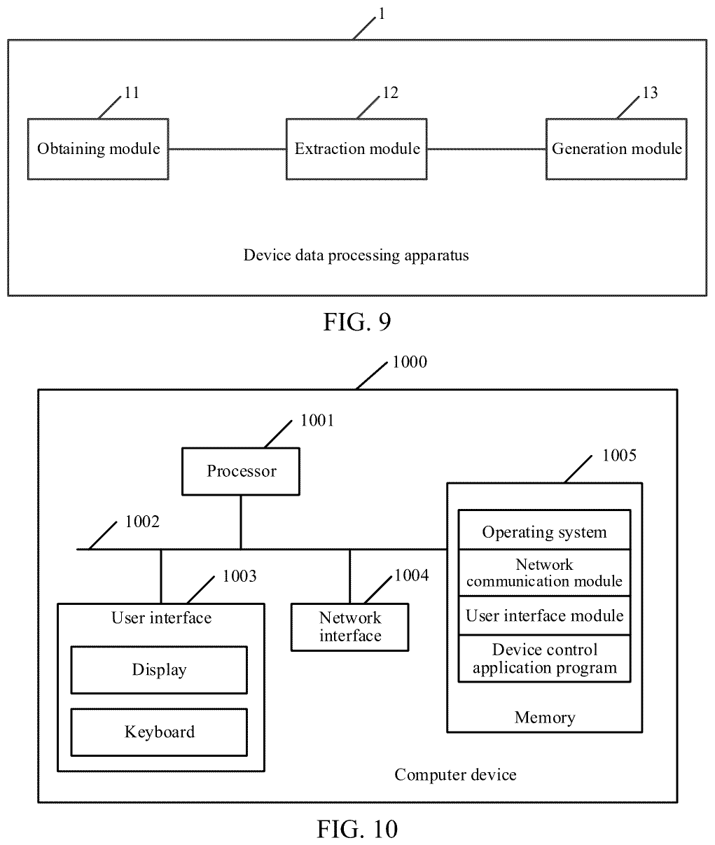

Referring to FIG. 9, FIG. 9 is a schematic structural diagram of a device data processing apparatus according to this disclosure. As shown in FIG. 9, the device data processing apparatus 1 may include: an obtaining module 11, an extraction module 12, and a generation module 13.

The obtaining module 11 is configured to obtain a target image collected by a target camera component, where the target camera component is a camera component in a target device.

The extraction module 12 is configured to extract a component imaging feature of the target camera component from the target image, where the component imaging feature is configured for reflecting photo response non-uniformity of the target camera component during imaging.

The generation module 13 is configured to generate a device fingerprint of the target device based on the component imaging feature.

In an embodiment, a manner of extracting, by the extraction module 12, the component imaging feature of the target camera component from the target image includes:
performing signal decomposition processing on the target image, to obtain an image noise signal included in the target image; and
generating the component imaging feature of the target camera component based on the image noise signal.

In an embodiment, a manner of generating, by the extraction module 12, the component imaging feature of the target camera component based on the image noise signal includes:
removing a low-frequency signal in the image noise signal to obtain a transition noise signal; and
generating the component imaging feature based on the transition noise signal.

In an embodiment, the transition noise signal includes noise signals of the target image in a plurality of reference directions, where a noise signal in one reference direction corresponds to one signal intensity coefficient, and the signal intensity coefficient is obtained by performing signal decomposition processing on the target image.

A manner of generating, by the extraction module 12, the component imaging feature based on the transition noise signal includes:
performing, in transition noise signals, denoising processing on a signal intensity coefficient corresponding to a noise signal in each reference direction, to obtain a denoised signal intensity coefficient in each reference direction; and
generating the component imaging feature based on the denoised signal intensity coefficient in each reference direction.

In an embodiment, the signal intensity coefficient corresponding to the noise signal in the reference direction includes a plurality of coefficient values.

A manner of performing, by the extraction module 12, in transition noise signals, denoising processing on the signal intensity coefficient corresponding to the noise signal in each reference direction, to obtain the denoised signal intensity coefficient in each reference direction includes:
performing variance estimation processing on the plurality of coefficient values in the signal intensity coefficient corresponding to the noise signal in the target reference direction, to obtain an estimated variance value in the target reference direction, where the target reference direction is any one of the plurality of reference directions; and
performing, based on the estimated variance value, denoising processing on the signal intensity coefficient corresponding to the noise signal in the target reference direction, to obtain a denoised signal intensity coefficient in the target reference direction.

In an embodiment, a manner of generating, by the extraction module 12, the component imaging feature based on the denoised signal intensity coefficient for each reference direction includes:
determining, based on the denoised signal intensity coefficient in each reference direction, a denoised noise signal in each reference direction;
separately performing inverse transform of decomposition on the denoised noise signal in each reference direction, to obtain a noise image in each reference direction; and
performing fusion processing on noise images in the reference directions, to obtain the component imaging feature.

In an embodiment, the signal decomposition processing is performed on the target image based on a wavelet transform method.

A manner of separately performing, by the extraction module 12, inverse transform of decomposition on the denoised noise signal in each reference direction, to obtain the noise image in each reference direction includes:
separately performing, based on an inverse transform method of the wavelet transform method, inverse transform of decomposition on the denoised noise signal in each reference direction, to obtain the noise image in each reference direction.

In an embodiment, the manner of extracting, by the extraction module 12, the component imaging feature of the target camera component from the target image includes:
obtaining an image cropping rule, where the image cropping rule is configured for defining a size and a position for image cropping;
cropping the target image according to the image cropping rule, to obtain a cropped image of the target image; and
extracting the component imaging feature from the cropped image.

In an embodiment, the target device has a related device type. The foregoing apparatus 1 is further configured to:
obtain a to-be-trained device classification network;
call the to-be-trained device classification network, and determine, based on the device fingerprint of the target device, a predicted device type corresponding to the target device;
modify, based on a difference between the predicted device type corresponding to the target device and the device type related to the target device, a network parameter of the device classification network.

In an embodiment, a manner of modifying, by the foregoing apparatus 1, based on the difference between the predicted device type corresponding to the target device and the device type related to the target device, the network parameter of the device classification network includes:
generating, based on the predicted device type corresponding to the target device and the device type related to the target device, a device classification loss of the device classification network for the target device, where the device classification loss is configured for reflecting the difference between the predicted device type corresponding to the target device and the device type related to the target device; and
modifying the network parameter of the device classification network based on the device classification loss.

In an embodiment, a quantity of target devices is multiple, where one target device has one related device type, and a plurality of target devices have a plurality of related device types;
one device corresponds to one predicted device type, where the predicted device type is any one of the plurality of device types.

In an embodiment, the foregoing apparatus 1 is further configured to:
obtain a verification image sent by a verification device, where the verification image is photographed by the verification device by calling a camera component in the verification device;
generate, based on the verification image, a device fingerprint of the verification device; and
call the device classification network, and predict, based on the device fingerprint of the verification device, a target device type to which the verification device belongs from the plurality of device types.

In an embodiment, the plurality of device types each respectively have a related device service.

The foregoing apparatus 1 is further configured to:
if the verification device initiates a call request for a target device service, and the target device service is consistent with a device service related to the target device type, provide the target device service to the verification device in response to the call request.

According to an embodiment of this disclosure, the operations involved in the device data processing method shown in FIG. 3 may be performed by the modules in the device data processing apparatus 1 shown in FIG. 9. For example, operation S101 shown in FIG. 3 may be performed by the module 11 shown in FIG. 9, operation S102 shown in FIG. 3 may be performed by the extraction module 12 shown in FIG. 9, and operation S103 shown in FIG. 3 may be performed by the generation module 13 shown in FIG. 9.

In this disclosure, a target image collected by a target camera component can be obtained, the target camera component being a camera component in a target device; a component imaging feature of the target camera component can be extracted from the target image, the component imaging feature being configured for reflecting photo response non-uniformity of the target camera component during imaging; and further, a device fingerprint of the target device can be generated based on the component imaging feature. Based on the apparatus provided in this disclosure, the device fingerprint of the target device can be generated based on the component imaging feature of the target camera component in the target device. The component imaging feature is configured for reflecting the exclusive and inherent photo response non-uniformity of the target camera component, and has high uniqueness and stability, therefore, the device fingerprint of the target device that has a strong binding and association relationship with the target camera component is generated based on the component imaging feature, ensuring that the device fingerprint is stable, and can be configured for accurately identifying a target device having the target camera component.

According to an embodiment of this disclosure, each module in the device data processing apparatus 1 shown in FIG. 9 may be separately or wholly combined into one or a plurality of units, or one (or more) of the units may further be divided into a plurality of subunits with smaller functions. In this way, the same operations may be implemented without affecting the implementation of the technical effects of the embodiments of this disclosure. The foregoing modules are divided based on logical functions. In actual application, a function of one module may further be implemented by a plurality of units, or functions of a plurality of modules are implemented by one unit. In another embodiment of this disclosure, the device data processing apparatus 1 may further include another unit. In practical application, these functions may be cooperatively implemented by another unit and may be cooperatively implemented by a plurality of units.

According to an embodiment of this disclosure, on a general computer device (the computer device may include a processing element and a storage element, such as a central processing unit (CPU), a random access medium (RAM), and a read-only medium (ROM)), computer programs that can implement each operation involved in the corresponding method shown in each embodiment of this disclosure may be run, to build the device data processing apparatus 1 shown in FIG. 9. The foregoing computer program may be recorded in, for example, a computer-readable recording medium, and may be loaded into the foregoing computer device by using the computer-readable recording medium, and run in the computer device.

Referring to FIG. 10, FIG. 10 is a schematic structural diagram of a computer device according to this disclosure. As shown in FIG. 10, a computer device 1000 may include: a processor 1001, a network interface 1004, and a memory 1005. In addition, in some embodiments, the computer device 1000 may further include: a user interface 1003, and at least one communication bus 1002. The communication bus 1002 is configured to implement connection and communication between these components. The user interface 1003 may include a display and a keyboard. In an embodiment, the user interface 1003 may further include a standard wired interface and a standard wireless interface. In an embodiment, the network interface 1004 may include a standard wired interface and a standard wireless interface (for example, a Wi-Fi interface). The memory 1005 may be a high-speed RAM memory, or may be a non-volatile memory, for example, at least one magnetic disk memory. In an embodiment, the memory 1005 may be at least one storage apparatus that is located far away from the foregoing processor 1001. As shown in FIG. 10, as a computer storage medium, the memory 1005 may include an operating system, a network communication module, a user interface module, and a device control application program.

In the computer device 1000 shown in FIG. 10, the network interface 1004 may provide a network communication function, the user interface 1003 is mainly an interface configured for providing input for a user, and the processor 1001 may be configured to call the device control application program stored in the memory 1005, to implement the device data processing method provided in this embodiment of this disclosure.

The computer device 1000 described in this embodiment of this disclosure can perform the descriptions about the device data processing method in each embodiment in this disclosure, and can also perform the descriptions about the foregoing device data processing apparatus 1 in the embodiment corresponding to FIG. 9. Details are not described herein again. In addition, the description of beneficial effects of the same method are not described herein again.

In addition, this disclosure further provides a computer-readable storage medium, and the computer-readable storage medium stores a computer program. When executing the computer program, a processor can perform the descriptions of the device data processing method in each embodiment of this disclosure. Therefore, details are not described herein again. In addition, the description of beneficial effects of the same method are not described herein again. For technical details that are not disclosed in the computer storage medium embodiments of this disclosure, refer to the descriptions of the method embodiments of this disclosure.

As an example, the foregoing computer program may be deployed to be executed on one computer device, on a plurality of computer devices located at one place, or on a plurality of computer devices distributed at a plurality of places and interconnected through a communication network. The plurality of computer devices distributed at the plurality of places and interconnected through the communication network may form a blockchain network.

The foregoing computer-readable storage medium may be an internal storage unit of the foregoing computer device, for example, a hard disk or memory of the computer device. The computer-readable storage medium may alternatively be an external storage device of the computer device, for example, a plug-in hard disk, a smart media card (SMC), a secure digital (SD) card, or a flash card equipped in the computer device. Further, the computer-readable storage medium may alternatively include both an internal storage unit and an external storage device of the computer device. The computer-readable storage medium is configured to store the computer program and other programs and data that are required by the computer device. The computer-readable storage medium may further be configured to temporarily store data that has been outputted or is to be outputted.

This disclosure provides a computer program product, including a computer program, where the computer program is stored in a computer-readable storage medium. A processor of a computer device reads the computer program from the computer-readable storage medium, and the processor executes the computer program to cause the computer device to perform the descriptions of the foregoing device data processing method in each embodiment in this disclosure. Therefore, details are not described herein again. In addition, the description of beneficial effects of the same method are not described herein again. For technical details that are not disclosed in the embodiments of the computer-readable storage medium in this disclosure, refer to the method embodiments in this disclosure.

In the specification, claims, and accompanying drawings of the embodiments of this disclosure, the terms “first”, “second”, and the like are intended to distinguish between different objects, instead of describing a particular order. In addition, the term “include” and any variation thereof are intended to cover a non-exclusive inclusion. For example, processes, methods, apparatuses, products, or devices including a series of operations or units are not limited to the listed operations or units, but instead, in an embodiment, include operations or units not listed, or include other operations or units inherent to these processes, methods, apparatuses, products, or devices.

It is noted that, in combination with the embodiments herein, units and algorithm operations of each example described may be implemented by electronic hardware, computer software, or a combination thereof. To clearly describe the interchangeability between the hardware and the software, the foregoing has generally described compositions and operations of each example based on functions. Whether these functions are performed by hardware or software depends on a specific application and a design constraint condition of the technical solutions. A person skilled in the art may use different methods to implement the described functions for each specific application, but such implementation is not to be considered as outside of the scope of this disclosure.

The foregoing disclosure includes some embodiments of this disclosure which are not intended to limit the scope of this disclosure. Other embodiments shall also fall within the scope of this disclosure.

What is claimed is:

1. A method of device data processing, the method comprising:
obtaining a target image that is collected by a target camera component of a target device;
extracting a component imaging feature of the target camera component from the target image, the component imaging feature reflecting photo response non-uniformity of the target camera component during imaging, and being extracted based on high-frequency noise components in the target image with frequencies higher than a frequency threshold; and
generating a device fingerprint of the target device based on the component imaging feature.

2. The method according to claim 1, wherein the extracting the component imaging feature comprises:
performing signal decomposition processing on the target image, to obtain an image noise signal of the target image; and
generating the component imaging feature of the target camera component based on the image noise signal.

3. The method according to claim 2, wherein the generating the component imaging feature comprises:
removing at least a low-frequency signal in the image noise signal to obtain a transition noise signal, the low-frequency signal having frequencies lower than the frequency threshold; and
generating the component imaging feature based on the transition noise signal.

4. The method according to claim 3, wherein:
the transition noise signal comprises respective noise signals in a plurality of reference directions, a noise signal in a reference direction corresponds to a set of signal intensity coefficient associated with a wavelet transform, and the set of signal intensity coefficient is obtained from the signal decomposition processing including the wavelet transform; and
the generating the component imaging feature based on the transition noise signal comprises:
performing denoising processing on respective sets of signal intensity coefficient corresponding to noise signals in the plurality of reference directions, to obtain respective sets of denoised signal intensity coefficient in the plurality of reference directions; and
generating the component imaging feature based on the respective sets of denoised signal intensity coefficient in the plurality of reference directions.

5. The method according to claim 4, wherein:
a first set of signal intensity coefficient corresponding to a first noise signal in a first reference direction of the plurality of reference directions comprises a plurality of coefficient values; and
the performing the denoising processing comprises:
performing variance estimation processing on the plurality of coefficient values in the first set of signal intensity coefficient to obtain an estimated variance value in the first reference direction; and
performing, based on the estimated variance value, the denoising processing on the first set of signal intensity coefficient to obtain a first set of denoised signal intensity coefficient in the first reference direction.

6. The method according to claim 4, wherein the generating the component imaging feature comprises:
determining, based on the respective sets of denoised signal intensity coefficient in the plurality of reference directions, respective denoised noise signals in the plurality of reference directions;
performing inverse transform of decomposition respectively on the respective denoised noise signals, to obtain noise images in the plurality of reference directions; and
performing fusion processing on the noise images in the plurality of reference directions, to obtain the component imaging feature.

7. The method according to claim 6, wherein the signal decomposition processing is performed on the target image based on the wavelet transform, and the performing the inverse transform of decomposition comprises:
performing, based on an inverse transform of the wavelet transform, the inverse transform of decomposition respectively on the respective denoised noise signals in the plurality of reference directions, to obtain the noise images in the plurality of reference directions.

8. The method according to claim 1, wherein the extracting the component imaging feature comprises:
obtaining an image cropping rule, the image cropping rule defining a size and a position for image cropping;
cropping the target image according to the image cropping rule, to obtain a cropped image of the target image; and
extracting the component imaging feature from the cropped image.

9. The method according to claim 1, wherein the target device has a device type, and the method further comprises:
obtaining a to-be-trained device classification network;
determining, by using the to-be-trained device classification network and based on the device fingerprint of the target device, a predicted device type for the target device; and
modifying, based on a difference between the predicted device type and the device type of the target device, at least a network parameter of the to-be-trained device classification network to obtain a trained device classification network.

10. The method according to claim 9, wherein the modifying comprises:
generating, based on the predicted device type and the device type of the target device, a device classification loss of the to-be-trained device classification network, the device classification loss reflecting the difference between the predicted device type and the device type; and
modifying the network parameter of the to-be-trained device classification network based on the device classification loss.

11. The method according to claim 9, wherein the target device is one of a plurality of target devices, each of the plurality of target devices has a device type from a plurality of device types, the predicted device type is one of the plurality of device types.

12. The method according to claim 11, wherein the method further comprises:
obtaining a verification image that is sent by a verification device, the verification image being photographed by a camera component in the verification device;
generating, based on the verification image, a device fingerprint of the verification device; and
predicting, by using the trained device classification network and based on the device fingerprint of the verification device, a target device type for the verification device from the plurality of device types.

13. The method according to claim 12, wherein:
each device type of the plurality of device types has a device service associated with the device type; and
the method further comprises:
when the verification device initiates a call request for a target device service, and the target device service is associated with the target device type, providing the target device service to the verification device in response to the call request.

14. An apparatus of device data processing, comprising processing circuitry configured to:
obtain a target image that is collected by a target camera component of a target device;
extract a component imaging feature of the target camera component from the target image, the component imaging feature reflecting photo response non-uniformity of the target camera component during imaging, and being extracted based on high-frequency noise components in the target image with frequencies higher than a frequency threshold; and
generate a device fingerprint of the target device based on the component imaging feature.

15. The apparatus according to claim 14, wherein the processing circuitry is configured to:
perform signal decomposition processing on the target image, to obtain an image noise signal of the target image; and
generate the component imaging feature of the target camera component based on the image noise signal.

16. The apparatus according to claim 15, wherein the processing circuitry is configured to:
remove at least a low-frequency signal in the image noise signal to obtain a transition noise signal, the low-frequency signal having frequencies lower than the frequency threshold; and
generate the component imaging feature based on the transition noise signal.

17. The apparatus according to claim 16, wherein:
the transition noise signal comprises respective noise signals in a plurality of reference directions, a noise signal in a reference direction corresponds to a set of signal intensity coefficient associated with a wavelet transform, and the set of signal intensity coefficient is obtained from the signal decomposition processing including the wavelet transform; and
the processing circuitry is configured to: :
perform denoising processing on respective sets of signal intensity coefficient corresponding to noise signals in the plurality of reference directions, to obtain respective sets of denoised signal intensity coefficient in the plurality of reference directions; and
generate the component imaging feature based on the respective sets of denoised signal intensity coefficient in the plurality of reference directions.

18. The apparatus according to claim 17, wherein:
a first set of signal intensity coefficient corresponding to a first noise signal in a first reference direction of the plurality of reference directions comprises a plurality of coefficient values; and
the processing circuitry is configured to:
perform variance estimation processing on the plurality of coefficient values in the first set of signal intensity coefficient to obtain an estimated variance value in the first reference direction; and
perform, based on the estimated variance value, the denoising processing on the first set of signal intensity coefficient to obtain a first set of denoised signal intensity coefficient in the first reference direction.

19. The apparatus according to claim 17, wherein the processing circuitry is configured to:
determine, based on the respective sets of denoised signal intensity coefficient in the plurality of reference directions, respective denoised noise signals in the plurality of reference directions;
perform inverse transform of decomposition respectively on the respective denoised noise signals, to obtain noise images in the plurality of reference directions; and
perform fusion processing on the noise images in the plurality of reference directions, to obtain the component imaging feature.

20. A non-transitory computer-readable storage medium storing instructions which when executed by at least one processor cause the at least one processor to perform:
obtaining a target image that is collected by a target camera component of a target device;
extracting a component imaging feature of the target camera component from the target image, the component imaging feature reflecting photo response non-uniformity of the target camera component during imaging, and being extracted based on high-frequency noise components in the target image with frequencies higher than a frequency threshold; and
generating a device fingerprint of the target device based on the component imaging feature.
